(19) United States
(12) Patent Application Publication
(10) Pub. No.: US 2012/0086667 A1
(43) Pub. Date: Apr. 12, 2012

(54) FORCE MEASURING METHOD FOR A MULTIMODE TOUCHSCREEN DEVICE

(75) Inventors: Philippe CONI, SAINT JEAN D'ILLAC (FR); Johanna DOMINICI, EYSINES (FR)

(73) Assignee: THALES, NEUILLY SUR SEINE (FR)

(21) Appl. No.: 13/252,909

(22) Filed: Oct. 4, 2011

(30) Foreign Application Priority Data
Oct. 6, 2010 (FR) 10 03955

(51) Int. Cl. G06F 3/045

(52) U.S. Cl. 345/174; 178/18.01

(57) ABSTRACT

A force measuring method for a touchscreen device makes it possible to measure the force applied to the touchscreen. The principle of the invention consists in measuring the displacement of the two plates supporting the conduction lines and columns of the touchscreen, a displacement which is proportional to the force applied. The displacement of the plates is known by analysis of the variation of the capacitive impedance induced by the presence of an actuator to displace the plates.

### CROSS-REFERENCE TO RELATED APPLICATION

This application claims priority to foreign French patent application No. FR 1003955, filed on Oct. 6, 2010, the disclosure of which is incorporated by reference in its entirety.

### FIELD OF THE INVENTION

The field of the invention is that of touchscreens. These screens are sensitive surfaces activated by the finger or the hand of a user and more often than not are used to control a device or a system through a graphical interface. There are a large number of possible uses. There are, in particular, the aeronautical applications in which a pilot can thus control and command all the functions displayed by the aircraft instrument panel.

### BACKGROUND

An ideal touch system, in addition to being capable of managing the displacement of one or more cursors by light touch and of managing the strokes of one or more keys, has to be able to associate with each stroke a corresponding force, along the axis normal to the surface of the touchscreen.

There are various “touchscreen” technologies, the main two being the capacitive touch surfaces and the resistive touch surfaces. The projected capacitive touch surfaces operate by acquisition of a change of electrical capacitance when the user moves his finger toward the touch surface. A light contact is sufficient, enabling the displacement of one or more cursors, but these touch surfaces do not work with a glove or any stylus. Furthermore, the validation conditional on a stroke force is not possible. As an example, the international application WO2004061808 describes a touch sensor of this type.

The resistive touch surfaces make it possible, to a certain extent, to monitor the stroke force, to work with gloves and any stylus. However, the displacement of a cursor by simple light touch is no longer possible.

On 17 Nov. 2009, the applicant filed a French patent application bearing the number 0905510. The device disclosed in the patent application provides a way to overcome the abovementioned drawbacks. In practice, it is capable of operating in capacitive mode when the finger approaches the screen, and in resistive mode upon a physical contact matched with a certain force.

However, the devices of the state of the art do not make it possible to give reliable information concerning the force applied by a user to the faceplate. The existing devices known from the state of the art use elements that are sensitive to pressure or displacement, placed roughly in the corners of the touch surface, such as, for example, in the international application WO2008065205A1. These devices give only the resultant of the force applied, not the number of stroke points nor their position and intensity.

Furthermore, they require an additional device, sensors, mechanical elements and conditioning electronics.

Another original embodiment means is described in the patent application US2009237374A1, but the touch surface has to be particularized by adding a pressure-sensitive element to it between its two active layers.

A hybrid means consisting in using a plurality of pressure-sensitive elements at the periphery of the screen is described in the international application WO2010027591A2. However, it is still not possible to measure the localized pressure of the stroke without adding pressure-sensitive components.

### SUMMARY OF THE INVENTION

The invention makes it possible to overcome the abovementioned drawbacks with a touchscreen device that is capable of measuring the force applied to the touchscreen.

More specifically, the invention relates to a method for measuring a force applied by an actuator to a touchscreen device comprising a rigid first substrate having a plurality of conductive lines and a flexible second substrate having a plurality of conductive columns perpendicular to said lines. Advantageously, the method comprises the following steps:
a first step of measuring the impedance that exists at the node between a line and a column,
a second step of computing the capacitive component of said impedance corresponding to the coupling capacitance at the node between the line and the column,
a third step of detecting the contact between the actuator and the surface of the touchscreen by the value of the capacitive component of said impedance,
a fourth step of analyzing the variation of the capacitive component of said impedance to measure the force applied to said touchscreen device after the instant corresponding to the contact between the actuator and the surface of the touchscreen, the variation of the capacitive component being proportional to the force applied.

Advantageously, in the fourth step, when a force is applied to the touchscreen, the variation of the capacitive component is computed at least during the time interval situated after the instant corresponding to the contact between the actuator and the surface of the touchscreen and before the instant corresponding to the contact between the first and the second substrate.

Advantageously, it comprises a fifth step of saving a mapping of the impedance that exists on each of the nodes between the lines and columns.

The invention also relates to the touchscreen device comprising a rigid first substrate having a plurality of conductive lines and a flexible second substrate having a plurality of conductive columns perpendicular to said lines. Advantageously, it also comprises acquisition electronics and processing electronics, the acquisition electronics being capable of measuring the impedance that exists at the node between a line and a column and the processing electronics being capable of computing the capacitive component of said impedance and of computing the force applied to said touchscreen device based on data concerning variations of the capacitive component of said impedance.

The invention relates to the display devices comprising at least one display screen and one touchscreen device according to the invention.

The display device may be an aircraft instrument panel display intended to be used separately or simultaneously by a pilot and a copilot.

### BRIEF DESCRIPTION OF THE DRAWINGS

The invention will be better understood and other advantages will become apparent from reading the following description, given as a nonlimiting example, and from the appended figures in which:

FIG. 1 represents the deformation of a touchscreen under the effect of pressure;

FIG. 2 represents the general principle of a touchscreen according to the invention;

FIG. 3 represents the electronic diagram of a touchscreen device according to the invention;

FIG. 4 represents the electronic diagram of an intersection comprising a line and a column of said touchscreen device;

FIGS. 5, 6, 7, 8 and 9 represent the variations of the impedance at said intersection generated by the finger or the hand of a user of said touchscreen in different situations;

FIGS. 10, 11 and 12 represent three usage modes of the touchscreen device according to the invention.

### DETAILED DESCRIPTION

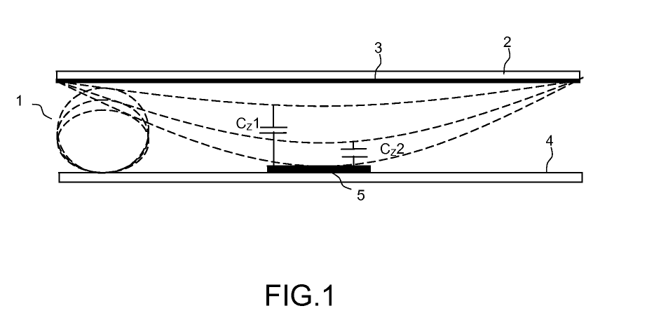

FIG. 1 represents the principle of capacitive detection of the force. The touch surface consists of a rigid plate 4 and a flexible plate 2, separated by an air space, which is maintained by spacers 1; this represents the current state of the art for the production of standard resistive touch surfaces. Upon a stroke, it is necessary to apply a force to deform this assembly, said force will depend on the rigidity of the plate 2, but also on the stiffness of the spacers 1. In a conventional “touchscreen”, only clear contact between the two plates is detected, the depression phase is unseen. The principle of the invention consists in measuring the displacement L of these two plates, a displacement which is proportional to the force applied. Effectively, if we consider the stiffness K of the assembly comprising plate 2 and stiffeners 1, the force applied locally is equal to the product K×L.

Also, a multiplexed “touchscreen” uses a network of conductive lines 3 and columns 5. There is therefore at least one intersection node at the level of the stroke, and this node has a corresponding coupling capacitance Cz.

Such a capacitance at a node is expressed as follows:

Cz=ε₀×εᵣ×S/L

where ε₀ is the permittivity of the space, εᵣ the relative permittivity of the environment contained between the two plates 2 and 4. S is the section at the intersection of a node, L is the distance between the two plates. The device and the method according to the invention make it possible to measure this capacitance Cz, in addition to the capacitance projected by the user and the resistance at the intersection of the nodes. It should be noted that the dielectric medium concerned may, conventionally, be air, but that it may be a liquid with suitable dielectric and viscous properties.

A first displacement of the flexible plate 2 is represented in FIG. 1 and the resulting capacitance at the node is equal to CZ₁. A second displacement of the flexible plate 2 is represented and the resulting capacitance at the node is equal to CZ₂.

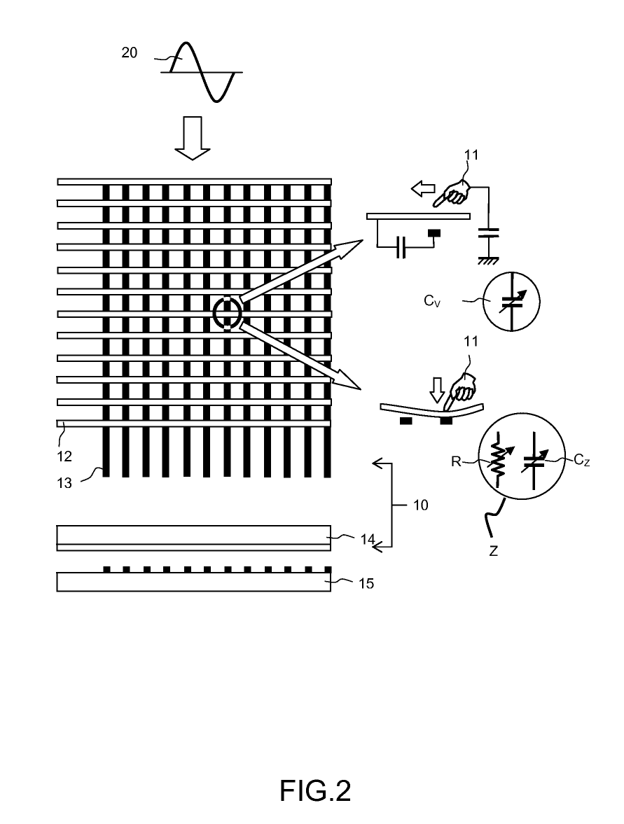

FIG. 2 represents the general principle of a touchscreen device 10 according to the invention. This figure comprises a plan view of the screen, a profile view and, on the right side of FIG. 2, two schematic diagrams showing the operation of the device depending on whether a user moves his hand 11 toward the screen 10 or touches it by exerting a pressure. As can be seen in this figure, the device comprises a touch faceplate 10 which is a multiplexed touch surface, consisting of lines 12 and columns 13 arranged facing a flexible substrate 14 and a rigid substrate 15. Such a device naturally operates in resistive mode. When a user presses on the flexible substrate 14, the local force provokes the contact of at least one line and one column at the node of the stroke causing a variation of the resistance R of the intersection of this line and this column that simply has to be measured to obtain the location of the stroke (diagram bottom right in FIG. 2). This type of faceplate is conventional and manufactured notably by the English company “Danielson”. The faceplate is also capable of operating in capacitive mode. It is in fact known that, when a user lightly touches a keyboard, his hand can cause variations of the capacitances C_{V} situated at the intersections of the lines and the columns of the touch faceplate. To provide this function, a generator 20 supplies the faceplate 10 with sinusoidal high frequency voltage via an injection capacitance. At high frequency, there is a natural capacitive effect C_{Z} at the intersections of the lines and the columns (diagram top right in FIG. 2). As seen previously, this value C_{Z} varies during the stroke, proportionally to the force applied.

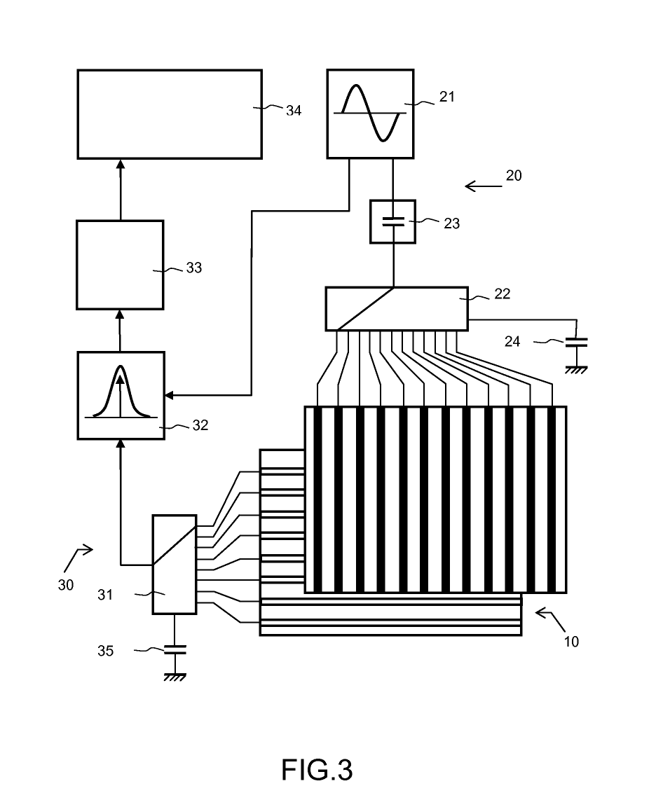

More specifically, and as a nonlimiting example, the whole of the touchscreen device according to the invention is represented in FIG. 3. It comprises:
a touch faceplate 10 consisting of lines and columns as described previously;
control electronics 20;
acquisition and processing electronics 30.

The control electronics 20 comprises:
a high-frequency voltage generator 21;
a first multiplexer 22 addressing the plurality of conductive lines 12 of the touch faceplate 10 through an injection capacitance 23, the voltage of the input signal being denoted V_{IN}. The multiplexer is not perfect and has capacitive losses 24 at the frequency concerned.

The acquisition and processing electronics 30 comprise:
a second multiplexer 31 addressing the plurality of conductive columns having capacitive losses 35;
a synchronous demodulator 32 operating at the same frequency as the high-frequency voltage generator 21 and delivering a plurality of output voltages V_{OUT} to each column;
an analogue-digital convertor 33 for converting the analogue signal into a digital signal;
computation, storage and monitoring means 34 for computing the impedance Z that exists between each output voltage and the input voltage, storing it, determining its resistive and capacitive components, deducing therefrom the type of action of the user on the touch faceplate (location of the stroke or strokes, and the force applied).

The synchronous demodulation performed by the demodulator 32 makes it possible to filter the so-called “EMI” electromagnetic disturbances by acting as a bandpass filter with high quality factor, which avoids the use of passive filtering. Furthermore, even if the disturbance is at a frequency close to the frequency of the generator 21, it is filtered by virtue of the high selectivity of the filter and because the disturbance can never be synchronous with the injection frequency. Additionally, the injection frequency can be varied slightly and pseudo-randomly so as never to be disturbed, including by a frequency that is identical and in phase.

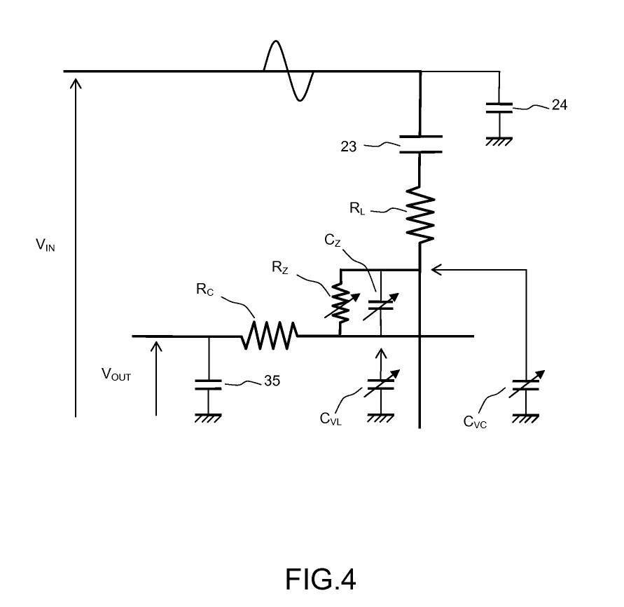

FIG. 4 represents the equivalent electrical circuit diagram of the device for a given line and column intersection. The line has an equivalent resistance R_{L}. The generator supplies this line through the injection capacitance 23. In parallel, the first input multiplexer has a capacitance 24. The column has an equivalent resistance R_{C}. In parallel, the second output multiplexer has a capacitance 35. At the intersection of the line and the column, the hand or the finger of the user will provoke a variation of the impedance Z that has both a resistive component R_{Z} and a capacitive component C_{Z}. The conventional relationship linking the input voltage and the output voltage is V_{OUT}=Z V_{IN} with, in complex form, Z=A+Bj.

The signal is then demodulated by the synchronous demodulator in order to extract therefrom the effective value V_{OUT}=V_{IN}*×√(A²+B²).

By virtue of the device according to the invention as described previously, it is possible to implement the force measuring method according to the invention which consists in carrying out the following steps:
In a first step, the characteristic impedance present at the node between a line and a column is measured. An impedance value that varies according to the force applied by an actuator, finger or stylus, for example, is measured. In this first step, the acquisition means can also measure other electrical characteristics at the node such as the output voltage on a column.
In a second step, at least the capacitive component of said impedance, corresponding to the coupling capacitance at the node between the line and the column, is computed. Other electrical impedance characteristics at the node can also be computed, such as the resistive component.
In a third step, the contact between the actuator and the surface of the touchscreen is detected by the value of the capacitive component of said impedance. The detection is possible because of the presence of an increase in the impedance at the node or a lowering of the output voltage present at the column at the node.
In a fourth step, the variation of the capacitive component of said impedance is analyzed to measure the force applied to said touchscreen device after the instant corresponding to the contact between the actuator and the surface of the touchscreen, the variation of the capacitive component being proportional to the force applied.

The variation of the capacitive component or of the output voltage at the column at the node is linked to the displacement of the flexible plate 2 and therefore to the force. The data processing means are used to determine this force by the measurement of this capacitive component or of the output voltage.

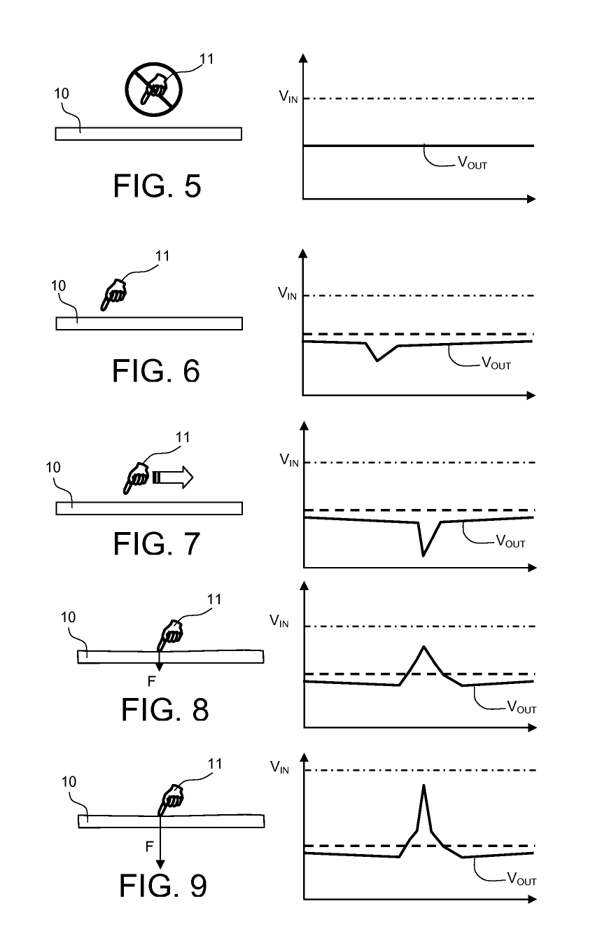

More specifically, FIGS. 5, 6, 7, 8 and 9 represent the variations of this effective value when the touch surface is used. In these figures, the left side shows the position of the hand 11 of the user relative to the touch surface 10 and the right side shows the graph representing the variation of the corresponding output signal V_{OUT} according to the position on a line stressed by the hand of the user. These graphs also show the input voltage V_{IN}.

In FIG. 5, the hand of the user is away from the touch faceplate. The line supplied is capacitively coupled to the columns, which forms a capacitive divider bridge with the measurement device which has a coupling capacitance relative to the ground. The signal obtained is at an intermediate potential between the power supply voltage V_{IN} and the ground, the resistance R_{Z} is infinite and the capacitance C_{Z} is at its minimum value, corresponding to a zero stroke force. This signal is, obviously, constant over the entire line.

FIG. 6 shows the light touch on the faceplate by the hand of the user. Light touch should be understood to mean the fact that the finger brushes or touches the touch faceplate without exerting any measurable pressure. The finger then projects a capacitance C_{V} which will couple, at the node, the line (C_{VL}) and the column (C_{VC}) to the ground, provoking a local attenuation of the signal as can be seen in the graph of FIG. 6. The finger acts as a local “pull-down”.

In case of pressureless contact as represented in FIG. 7, the coupling capacitance increases up to a threshold then remains constant. The signal reduces to a minimum. It is thus possible to follow the displacement of the finger.

In case of contact with pressure but without contact between the two plates 14 and 15 as represented in FIG. 8, during a stroke, and according to the force applied, the capacitance C_{Z} between lines and columns increases, because of the nearing of the two plates. This increase in the coupling capacitance results in a reduction in the impedance Z at the node (Z varies proportionally to 1/C_{Z}). The finger is said to act as a local “pull-up”.

In case of contact with pressure and with contact between the two plates 14 and 15 as represented in FIG. 9, during a stroke, and depending on the force applied, either a capacitance is created between the point of contact and the ground, or a contact resistance is created between lines and columns. In the case of a physical contact with pressure, the line/column capacitive coupling C_{Z} disappears, the resistance R_{Z} decreases, which results in a lowering of the impedance Z at the node (the signal increases). The finger is said to act as a local “pull-up”.

Thus, a simple analysis of the signal at a line/column intersection very simply makes it possible to determine:
absence of the hand: the signal is constant;
light contact: the signal decreases locally;
contact: the signal reaches a minimum;
contact with pressure but without contact between the two plates: the signal increases;
contact with contact between the two plates: the signal reaches a maximum.

To give an idea of the orders of magnitude, the variations of capacitance to be detected are of the order of a few tens of picofarads and the variations of resistance to be detected are of the order of a few tens of ohms.

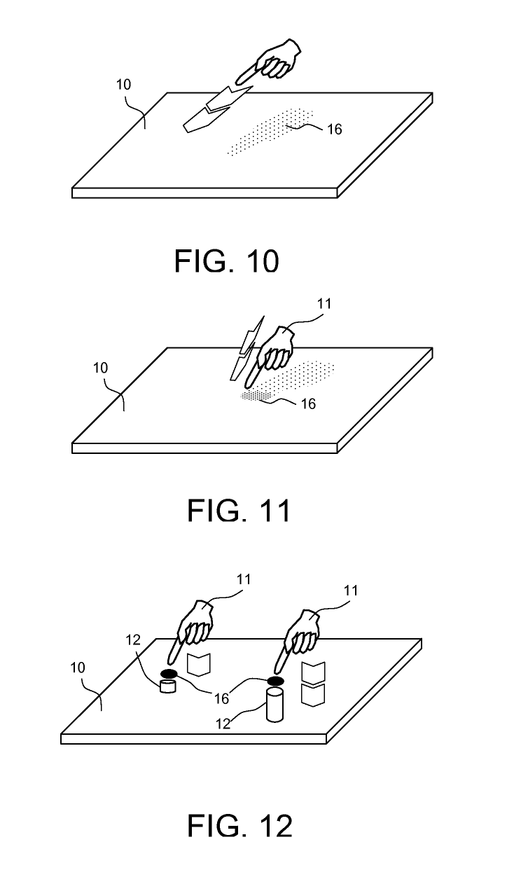

Obviously, it is possible to produce a complete mapping of the signals over all the matrix of line/column intersections. It is then possible to define three detection modes, detailed below and represented in FIGS. 10, 11 and 12:

FIG. 10: so-called “projected capacitive” mode for detecting the approach of the hand or the finger, and its direction of approach. In FIG. 10, the intersections 16 of the faceplate 10 where the signal is representative of this mode are represented lightly shaded;

FIG. 11: so-called “discrete capacitive” mode for detecting that one or more fingers lightly touch the surface, which makes it possible to provide multiple-cursor management. In FIG. 11, the intersections 16 of the faceplate 10 where the signal is representative of this mode are represented with dark shading;

FIG. 12: so-called “capacitive-resistive” mode: before the resistive contact, the capacitance 12 resulting from the convergence of the two plates gives pressure and position information. From a certain pressure corresponding to the contact of the two plates, the analysis of the contact resistance, and possibly of the section of the stroke, makes it possible to give position and pressure information. In FIG. 12, the intersections 16 of the faceplate 10 where the signal is representative of this mode are represented in black; the variation of the signal is used to determine the intensity of the pressure. Thus, the hand 11 on the right in FIG. 12 presses more strongly on the touch faceplate 10 than the hand 11 shown on the left in this same figure causing a stronger and more extended signal variation.

In the absence of an approach of the hand, the touch monitor of the device may permanently make an “image” of the signals from the faceplate and deduce therefrom a “table” of the signals when idle by sliding average, this table being stored. This image is subtracted from the table of the instantaneous values, to form the table of differences, from which it is possible to assign each point or each intersection its status.

Such a device is therefore “multitouch” and can be used to manage the displacement of one or more cursors by light touch in capacitive mode, with the possibility of passing over buttons without unwanted activation. A simple pressure makes it possible to validate one or more objects, the analysis of the coupling capacitance at the nodes makes it possible to measure the pressure, and similarly the stroke surface makes it possible to measure the deformation of the finger, and therefore the pressure, which gives a third detection axis. It is thus possible to have genuine three-dimensional information on the position of the hand.

Among the new functions that can be accessed by the touchscreen, according to the invention, when it is coupled with a graphic screen displaying information, windows or icons like those of the “Windows” software marketed by the company Microsoft, there are also:
Segregation of the cursors and of the strokes
On a conventional touch surface, a cursor cannot be dissociated from the state of a validated object. Passing over it with the finger causes it to be activated. In the device according to the invention, the objects are validated if the signal is in “pull-up” mode. The cursors are managed only in “pull-down” mode. They disappear in case of loss of signal. The validation is active only in “pull-up” mode, that is to say when the user physically presses on the screen, and can also be conditional on a certain pressure threshold.
Securing or “monitoring”
In a conventional matrix resistive “touchscreen”, the loss of a line or of a column is not detectable, because the “idle” state, that is to say when there is no hand of the user present, is at high impedance. The use of an alternating current makes it possible to benefit from the capacitive coupling at the nodes. The idle state is thus represented by an intermediate level due to the resistive bridge. A cut-off is easily detectable, by loss of the idle signal.
Creation of virtual keyboards or “touchpads”
A virtual keyboard can be created on the graphic screen. Only the “pull-up” function is then used in this area (resistive mode with stroke pressure). It is also possible to create a “touchpad” area. In this case, the management is only in “pull-down” mode with displacement by light touch (capacitive mode with light touch)
Three-dimensional management of the touchscreen.

Inasmuch as it is possible to identify a number of superimposed stroke planes, and, on the resistive plane, measurement of the force is possible, an axis perpendicular to the plane of the touchscreen can be used and makes it possible to manage or simulate, for example, the controlled depression of a control member.

The invention applies to the display devices that comprise a touchscreen and, more generally, to any interaction device comprising a touchscreen on which the aim is to measure the force applied to the touchscreen.

1. A method for measuring a force applied by an actuator to a touchscreen device comprising a rigid first substrate having a plurality of conductive lines and a flexible second substrate having a plurality of conductive columns perpendicular to said lines comprising the following steps:
a first step of measuring the impedance that exists at the node between a line and a column,
a second step of computing the capacitive component of said impedance corresponding to the coupling capacitance at the node between the line and the column,
a third step of detecting the contact between the actuator and the surface of the touchscreen by the value of the capacitive component of said impedance, and
a fourth step of analyzing the variation of the capacitive component of said impedance to measure the force applied to said touchscreen device after the instant corresponding to the contact between the actuator and the surface of the touchscreen, the variation of the capacitive component being proportional to the force applied.

2. The method as claimed in claim 1, wherein the detection of contact performed in the third step between the actuator and the surface of the touchscreen is reflected in the presence of an increase in the impedance at the node between a line and a column or a lowering of the output voltage present at the column at said node.

3. The method as claimed in claim 1, wherein, in the fourth step when a force is applied to the touchscreen, the variation of the capacitive component is computed at least during the time interval situated after the instant corresponding to the contact between the actuator and the surface of the touchscreen and before the instant corresponding to the contact between the first and the second substrate.

4. The method as claimed in claim 1, further comprising a fifth step of saving a mapping of the impedance that exists on each of the nodes between the lines and columns.

5. A touchscreen device comprising:
a rigid first substrate having a plurality of conductive lines and a flexible second substrate having a plurality of conductive columns perpendicular to said lines,
acquisition electronics and processing electronics, the acquisition electronics being capable of measuring the impedance that exists at the node between a line and a column and the processing electronics being capable of computing the capacitive component of said impedance and of computing a force applied and/or of locating one or more strokes on said touchscreen device based on data concerning variations of the capacitive component of said impedance.

6. A display device comprising at least one display screen and one touchscreen device, wherein the touchscreen device is as claimed in claim 5.

7. The display device as claimed in claim 6, wherein the device is an aircraft instrument panel display intended to be used separately or simultaneously by a pilot and a copilot.
